(19) United States
(12) Patent Application Publication
(10) Pub. No.: US 2003/0147718 A1
(43) Pub. Date: Aug. 7, 2003

(54) Compression fastener assembly

(76) Inventors: Charles L. McDowell, Richmond, VA (US); Winston T. Sanders SR., Chesterfield, VA (US)

Correspondence Address: O'MALLEY AND FIRESTONE, 919 SOUTH HARRISON STREET, SUITE 210, FORT WAYNE, IN, 46802, US

(21) Appl. No.: 10/272,213

(22) Filed: Oct. 16, 2002

Related U.S. Application Data
(60) Provisional application No. 60/354,223, filed on Feb. 4, 2002.

(51) Int. Cl. F16B 23/00

(52) U.S. Cl. 411/396

(57) ABSTRACT

The invention relates to a fastener assembly having a fastener with a moveable collar and a method of using the fastener assembly to fasten two work pieces together.

### PRIORITY

The present application claims the benefit of U.S. provisional patent application No. 60/354,223 filed on Feb. 4, 2002.

### BACKGROUND OF THE INVENTION

1. Field of the Invention

The present invention relates to a fastener assembly and a method for using the fastener assembly.

2. Description of the Prior Art

During construction or assembly, workers often fasten work pieces together. If these work pieces require compression, a worker usually attaches a clamp to both work pieces, such as two pieces of metal, to hold the work pieces together.

Clamps, however, have a number of drawbacks. Some work pieces are not easily clamped. Clamps can deform soft flexible work pieces or break fragile work pieces, especially if overtightened. A clamp may attach poorly, if at all, to work pieces with nonplanar or irregular exterior surfaces. The nonplanar shape may not allow the clamp to grip the nonplanar surfaces. Clamps cannot be used in some applications, for example, attaching items to a wall or a ceiling or other large work pieces. The location of the work pieces in tight or restricted locations does not allow for the use of a clamp either.

Some work pieces are compressed together with a plate rather than a clamp. Plates are usually anchored by fasteners, such as screws, rivets or bolts. These plates, however, are planar and are difficult to use on nonplanar surfaces. Plates also require that the fasteners insert perpendicularly to the exterior of the surface.

There are many types of fasteners available, including rivets, screws, bolts and the like. Most of these fasteners, however, are designed to fasten planar objects together. These fasteners require the fastener head to be flush against the first piece's exterior, reducing its ability to be used on nonplanar surfaces. Rivets, for example, fasten planar plates together and must be flush against the surface. In addition, inserting a fastener at an angle reduces the fastener's ability to hold the pieces together.

For many fasteners, the work pieces must be predrilled before assembling. This requires shafts to be drilled in two different work pieces, then aligned before inserting the fastener. If misaligned, the fastener may not insert within the second piece or become angled and not flush with the work piece. This angled attachment would decrease the fastener's ability to hold the pieces together. An angled fastener is also difficult to remove in order to repair the work pieces.

Therefore, one object of the invention is to develop a fastener assembly to compress work pieces together. A second object of the invention is to produce a fastener assembly to fasten and compress flexible or nonplanar work pieces together. A third object of the invention is to develop a fastener assembly that fastens work pieces in restricted locations where the pieces cannot be clamped together. Another object of the invention is to develop a fastener assembly that can insert into the work piece at an angle. Still another object of the invention is to produce a fastener assembly that is easy to insert and remove without damaging the work pieces.

### SUMMARY OF THE INVENTION

The invention relates to a fastener assembly and a method of fastening first and second work pieces together. The fastener assembly has a fastener and a moveable collar. The fastener has a tip, a shank having a shank end distal to the tip, and an intermediate section located between the tip and the shank. The collar has first and second ends as well as a smooth interior wall surrounding the shank. The collar is located between the intermediate portion and the shank end.

The method of the invention places the collar onto the shank of the fastener. After fitting the work pieces together, the tip and intermediate sections insert through the first work piece into the second work piece. The collar is moved along the shank to the exterior of the first work piece and locked against the shank. After locking the collar, the work pieces remain fitted together.

Additional effects, features and advantages will be apparent in the written description that follows.

### BRIEF DESCRIPTION OF THE DRAWINGS

FIG. 1 is a perspective view of one embodiment of a fastener assembly of the invention;

FIG. 2 is a perspective view of a collar of the invention;

FIG. 3 is a side view of one embodiment of a fastener assembly of the invention within two work pieces;

FIG. 4 is a side view of a fastener assembly of the invention inserted into a fractured work piece;

FIG. 5 is a side view of fastener assemblies of the invention installed within two work pieces;

FIG. 6 is a plan view of another embodiment of a fastener assembly of the invention illustrating the movement of a collar down the shaft of the fastener and showing two work pieces in phantom;

FIG. 7 is a side view of another embodiment of a fastener assembly of the invention;

FIG. 8 is a side view of another embodiment of a fastener assembly of the invention;

FIG. 9 is a side view of another embodiment of a fastener assembly of the invention;

FIG. 10 is a cross-sectional view of a method of inserting the fastener assembly using an insertion guide; and

FIG. 11 is a cross-sectional view of another insertion guide of the invention.

### DETAILED DESCRIPTION OF THE INVENTION

Turning to the figures where like reference numerals refer to like structures, fastener 10 of the invention has tip 12, shank 14 and intermediate section 16 therebetween. Preferably, fastener 10 is a long, thin rod with a length much longer than its cross-sectional diameter. Fastener can be the diameter of a wire or pin.

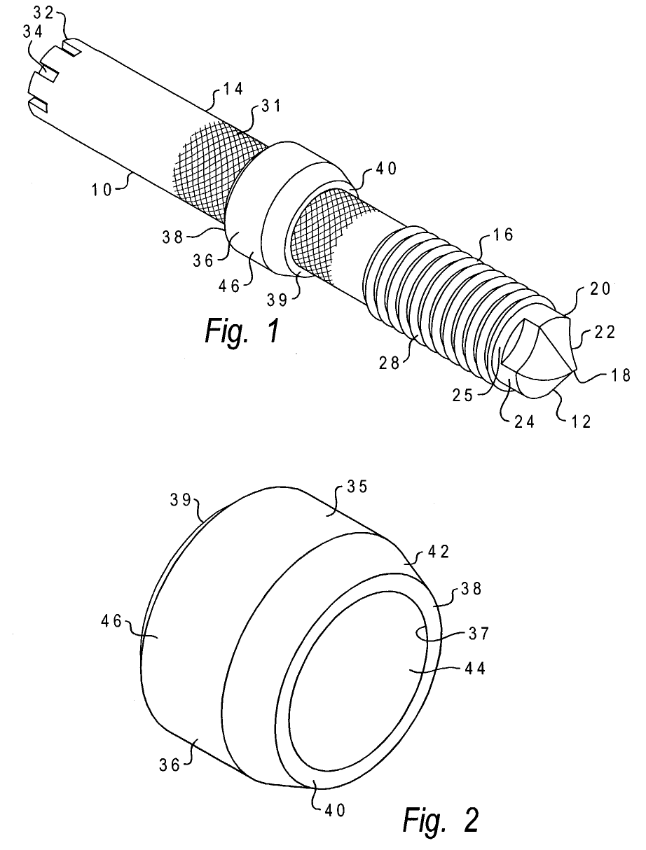

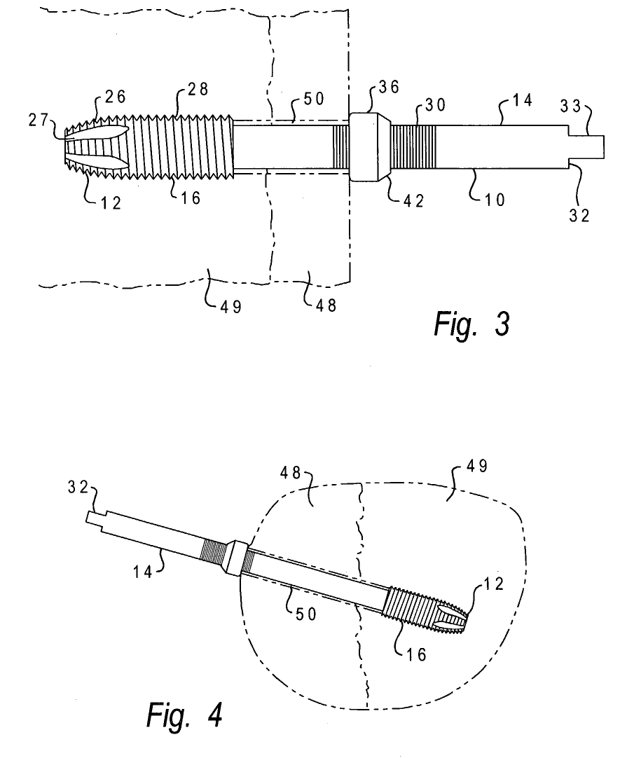

Tip 12 is preferably tapered and cutting with cutting point 18, such as a spade or a trocar tip, and/or blades 20 with grooves 22 located therebetween and terminating in cutting point 18. The tip can also include margin 25 and guiding surface 24 between blades 20 and intermediate section 16 (FIG. 1). Guiding surface 24 helps orient fastener 10 at the desired angle and prevents cutting when at an incorrect angle to minimize damage to the material. Alternatively, tip 12 can be cutting thread 26 with grooves 27, the design of which can also reduce burring during cutting (FIG. 3).

Intermediate section 16 can be textured, such as threaded, ribbed, fluted, and the like, to help pull fastener 10 into the work piece during insertion. Threads 28, for example, are helical.

Shank 14 is longer than intermediate section 16 and tip 12 and comprises more than half of fastener 10. Shank 14 can be textured or smooth, depending on the application. Texturing includes ribs 30 perpendicular to the shank's longitudinal axis, knurling 31, ridges, barbs, hooks, and the like, or a combination of textures at different locations. Shank 14 has shank end 32 which can fit within a chuck or collet of a tool. Such designs can include a flat rectangular end 33 (FIG. 3), teeth, ridges, grooves, and the like, or a combination thereof. Grooves 34, for example, are parallel to the shank's axis which mate with similar ridges on a tool's collet (FIG. 1).

As shown in FIGS. 1 and 3, moveable collar 36 fits onto shank 14. FIG. 2 shows collar 36 having first 38 and second 39 collar ends, and wall 40 having an exterior 35 and an interior 37. Wall 40 defines bore 44. The interior of wall 40 frictionally engages shank 14 and, if desired, bore 44 can be slightly smaller in diameter than shank 14. Interior 37 can be smooth or textured, depending on the application and shank. For example, interior 37 is preferably smooth if used with a textured shank 14 and textured if used with a smooth shank 14.

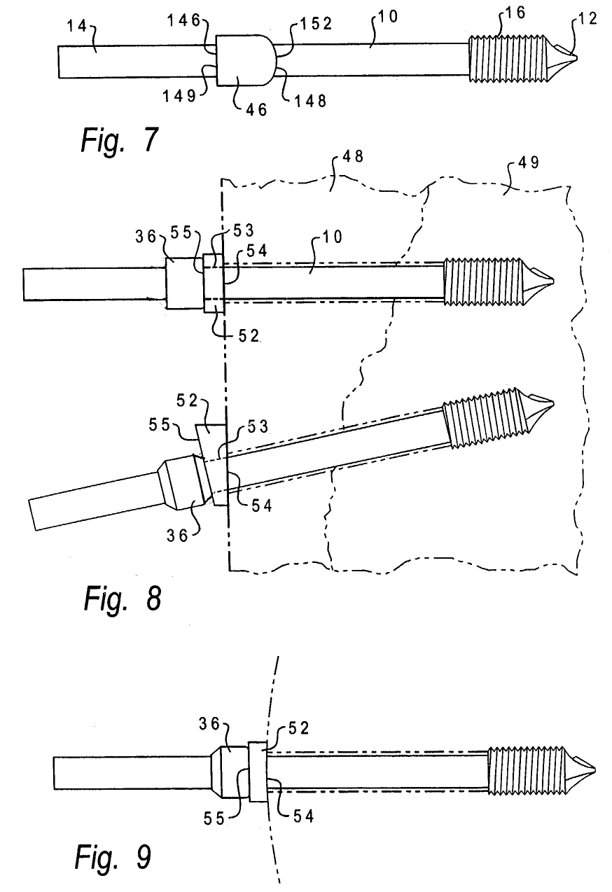

First collar end 38 and second collar end 39 of collar 36 can have different shapes depending on the application. Collar 36, as shown in FIG. 2 for example, can be at least partially frustro-conical, the frustro-conical portion 42 increasing in diameter in cross-section from first collar end 38 until reaching a maximum diameter either at second collar end 39 or at band 46 adjacent to second collar end 39. Bore 44 is preferably of constant diameter from first collar end 38 to second collar end 39. The wall's width, however, preferably varies from first collar end 38 to second collar end 39. Band 46 can be contoured to generate uniform pressure while in use as described below and thus can be of constant diameter or slightly decreasing in diameter in cross-section until reaching second collar end 39. Another alternative is shown in FIG. 7 where collar 146 is at least partially parabolic or convex, with the parabolic portion 152 increasing in diameter in cross-section from one end 148 toward band 46. Band 46 is constant in diameter in cross-section until reaching second end 149. One end can also be concave, if desired (not shown).

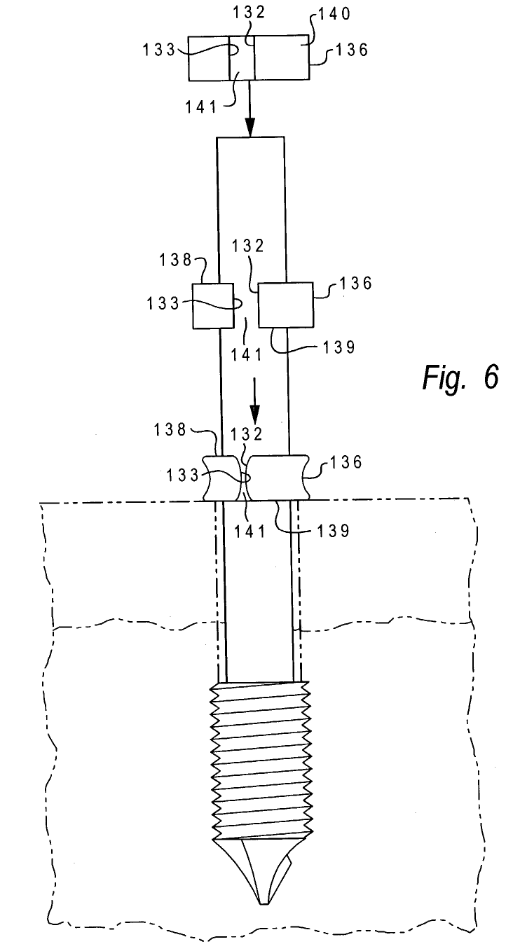

Alternatively as shown in FIG. 6, collar 136 can be of constant diameter in cross-section from first collar end 138 to second collar end 139 and can have slit 141, defined by circumferential wall 140 having first 132 and second 133 ends, if desired. The bore of collar 136 is slightly wider in diameter than shank 14 and therefore does not frictionally engage shank 14. Collar 136 can be crimped, however, which narrows slit 141 and allows collar 136 to frictionally engage shank 14.

In the method of the invention shown in FIGS. 3-5, fastener 10 partially inserts within work pieces 48, 49, which can be clamped together if desired. Before insertion, tip 12 is aligned in the desired position on the exterior of first work piece 48.

If desired gasket 52, ring or washer can be placed between work piece 48 and collar 36 (FIGS. 8 and 9). Gasket 52 has first gasket end 54 adjacent work piece 48 and the second gasket end 55 adjacent collar 36 and has a central borehole 53. Gasket ends 54, 55 can have different shapes depending on the use, such as a concave first gasket end 54 with a flat second gasket end 55 (FIG. 9) or a flat first gasket end 54 and second gasket end 55 angled in comparison to first washer end 54 (FIG. 8). In addition to gasket 52 having different shapes, central borehole 53 can be shaped and sized for the application. For example, central borehole 53 is preferably adapted to fit the fastener, which will normally be circular with a diameter wider than shank 14. Central borehole 53 can also be ovoid rather than circular to allow gasket 52 to tip or another shape if so desired. Gasket 52 can assure that the long, thin fastener is inserted at the correct angle.

During insertion, the texture of intermediate piece 16 should help pull fastener 10 through shaft 50 within work pieces 48, 49 to the desired depth. In addition, the texture of intermediate section 16 should help anchor or hold fastener 10 within second work piece 49. The texturing of shank 14 is preferably unidirectional to ease the movement of collar 36 toward work piece 48 and to prevent collar 36 from moving away from the piece 48 during compression.

Shaft 50 can be predrilled into one or both of work pieces 48, 49 and fastener 10 inserted after drilling. Alternatively, fastener 10 itself can form or enlarge shaft 50 by cutting or drilling into work pieces 48, 49 during insertion. In this embodiment, shank end 32 of shank 14 is inserted into the chuck of a drill before drilling.

The first position of collar 36 on shank 14 can correspond with the depth of shaft 50, which is often less than the width of work pieces 48, 49 combined. When used in this manner, the collar serves as a stop during insertion after reaching the first work piece's exterior.

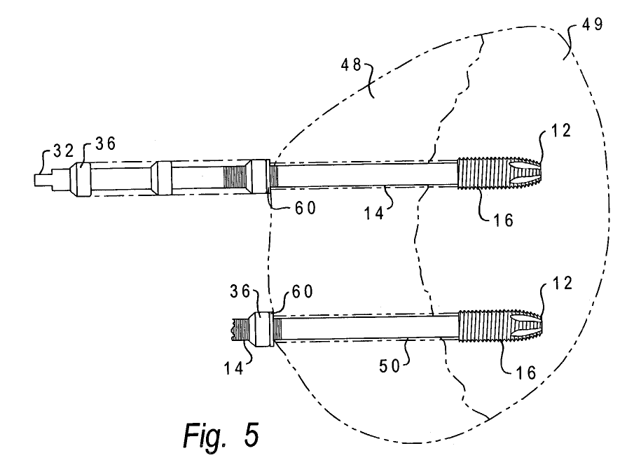

Once fastener 10 is positioned within shaft 50, collar 36 is moved on shank 14 to the exterior of first work piece 48. Next, collar 36 is forced against first work piece 48 or gasket 52 where collar 36 locks into position. Any texturing of shank 14 in this position should aid in locking the collar in position. Collar 36 also can be crimped after moving down shank 14, if desired. After collar placement, shank 14 can be cut at first end 38 of collar 36 or preferably left intact for later removal. For larger pieces, additional fasteners can be used (FIG. 5).

FIG. 6 shows fastener 10 positioned within the shaft. Collar 136 slides down shaft 14 until reaching the exterior of first work piece 48. Collar 136 now is preferably crimped to frictionally engage shank 14 to lock fastener 10 in place.

The tight frictional fit of the collar against shank should prevent the collar from moving on the shank until desired. Because of this fit and the pressure of forcing the collar against the first piece, a tool can be used to provide sufficient external force to ensure adequate compression. Examples of tools include pliers, spreaders, wrenches or compression tools such as a rivet tool adapted to push the collar.

FIG. 5 shows the fastener of the invention partially inserted within irregularly shaped work pieces 48,49. Due to the shape of the pieces, no clamp can be used to hold the work pieces together. Collar 36 is positioned on shaft 14. Adhesive is applied to work pieces 48, 49, which are then placed together. Fastener 10 is drilled into work pieces 48, 49. Next, collar 36 is compressed or forced against work piece 48. After compression, shaft 14 is cut or preferably left intact and collar 36 remains locked in position against work piece 48. Alternatively after partially inserting the first fastener but before compression, additional fasteners are similarly partially inserted into the pieces. Next, each collar is positioned in turn against work piece 48. Gasket 52 can be placed against workpiece 48, and tip 12 inserted into borehole 53 before drilling fastener 10 into workpieces 48,49. For permanent use, the fastener with collar can be countersunk within the shaft and the shaft cut after insertion (not shown).

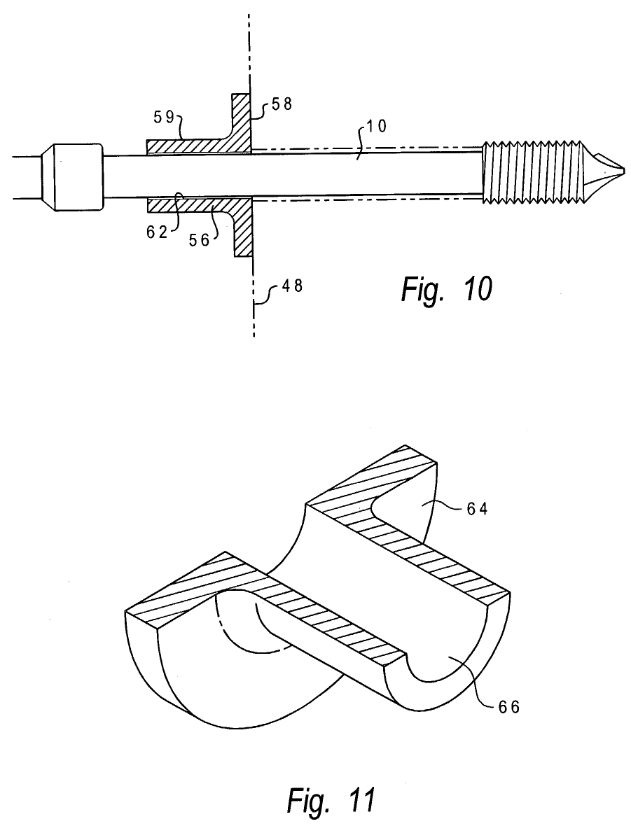

Because of the length of the fastener, an insertion guide such as a jig can maintain the fastener in a perpendicular angle of insertion to the exterior of the work piece, especially if drilling and inserting are simultaneous. FIG. 10 shows T-shaped insertion guide 56 with flanged end 58 fitting against work piece 48 and a cylindrical stem 59. Central passageway 62 is adapted to loosely fit fastener 10. Insertion guide 56 can be round. Alternatively, insertion guide 64 has trough 66 onto which fastener 10 rests during insertion (FIG. 11).

Removal of the fastener is simple. If the shank is cut, the collar is cut off and removed or pulled off the cut shaft with a tool, such as a wrench. This will expose a small nub of the cut shaft which can be gripped by a tool, such as a drill chuck, and the fastener rotated until removed from the pieces. Preferably the shank remains intact and the fastener is rotated in the opposite direction to its installation to back it out, such as with a drill chuck attached to the shank end.

The fastener and collar can be made from any material used for fasteners, such as screws and rivets, and are well known in the art. The material includes metals, such as aluminum, brass, nickel, stainless steel, zinc, cobalt chromium, molybdimum, titanium, and the like, and plastics with or without fillers, examples of which include polymers and copolyers such as nylon 6/6 and 6, high molecular weight polyethylene, ultrahigh molecular weight polyethylene, and the like. The collar should frictionally fit against the shank and maintain compression and position on the shank after removing external compressive forces. If a collar is used as shown in FIG. 6, the collar is made of a material that can be crimped to frictionally fit against the shank before moving into position against the work piece or crimped after placement into position. If desired, the collar can be made from material that is less rigid than the fastener, such as a polymer or copolymer collar with a metal fastener. Gaskets can also be made of a compressible material, such as plastic polymers and copolymers, like silicone, latex, rubber, and the like.

The fastener and collar can be part of a kit of parts. The kit would have fasteners of different diameters that could be used as needed. The kit could also have one or more collars to fit onto the fasteners. A kit with a slit collar 136 for example, would only need one collar as it can be crimped to frictionally fit against shank 14 or expand to fit against a larger shank. A kit with collar 36, however, may require several sizes of collars. Because collar 36 frictionally fits against shank 14, one bore may fit onto fasteners with a variety of diameters ranging in size from one equal to the bore to one smaller than the bore. To accommodate a variety of conditions, the kit may also include collars with differing ends, such as one end being parabolic and the opposite end being flat. A set of gaskets with different shapes and/or thicknesses could be included in a kit of parts to accommodate a variety of angles of the fastener insertion relative to the surface into which the fastener is inserted. The kit may also include the insertion guide.

The easy to use fastener assembly of the invention has many advantages over other fasteners. The tight frictional fit of the collar against the shank keeps the collar in position against the pieces and maintains compression. The fastener assembly fastens nonplanar work pieces together. Most prior art fasteners require the fastener head to be flush with the first piece's exterior, reducing its ability to be used on nonplanar surfaces. Rivets, for example, fasten planar plates together and must be flush against the surface. The fastener, therefore, can insert at an angle instead of flush with the surface, yet the collar forces the pieces together by compression. Additionally, multiple fasteners can be inserted in multiple planes for added strength for fixation as compared to single or double plane fixation using screws or plates.

Another advantage is that the fastener assembly fastens work pieces in restricted locations where the pieces cannot be easily clamped together, if at all. Additionally, the collar of the fastener is easily seen on the worker's side, not a blind side to assure the worker that the collar is properly placed and locked in position.

The work pieces do not have to be predrilled before inserting the fastener. If a cutting tip is used, the fastener can cut into both work pieces to reduce alignment problems.

The fastener assembly can be used with nontraditional materials that are less rigid than metals or wood. This can include plastics that are more resilient and flexible. Because the diameter of the fastener is small relative to the size of the work pieces, the risk of damage to the work pieces is reduced.

Unlike rivets, the fastener assembly is easy to remove and can be reused if uncut.

While the invention is shown in only one of its forms, it is not thus limited but is susceptible to various changes and modifications without departing from the spirit and scope of the invention.

What is claimed is:

1. A fastener assembly comprising:
a fastener comprising a tip, a shank having a shank end distal to the tip, and an intermediate section located between the tip and the shank; and
a moveable collar having first and second ends, and a wall having an exterior and a smooth interior surrounding the shank, the collar being located between the intermediate portion and the shank end.

2. A fastener assembly of claim 1, wherein:
the intermediate section is textured.

3. A fastener assembly of claim 2, wherein the tip further comprises:
cutting means.

4. A fastener assembly of claim 3, wherein the shank end is adapted to fit within a collet of a tool.

5. A fastener assembly of claim 3, wherein the shank is at least partially textured.

6. A fastener assembly of claim 5, wherein the interior of the wall of the collar frictionally engages the shank.

7. A fastener assembly of claim 6, wherein the collar further comprises:
a slit from the exterior of the wall to the interior of the wall.

8. A fastener assembly of claim 7, wherein the collar is at least partially frustro-conical and increases in diameter in cross-section from the first collar end.

9. A fastener of claim 8, wherein the collar further comprises:
a band adjacent to the second collar end.

10. A method of fastening first and second work pieces together, comprising the steps of:
providing a fastener comprising a tip, a shank having a shank end distal to the tip, and an intermediate section located between the tip and the shank;
placing a collar having first and second ends, and a wall having an exterior and a smooth interior onto the shank;
placing the first and second work pieces together;
aligning the tip on the first work piece;
forming a shaft in the first piece;
inserting the tip and intermediate section through the first work piece and into the second work piece;
moving the collar along the shank to the exterior of the first work piece;
locking the collar against the shank; and
keeping the work pieces together after locking the collar.

11. A method of fastening first and second work pieces together of claim 10, further comprising the step of:
helping pull the fastener into the first work piece with the intermediate section; and
wherein the intermediate section is textured.

12. A method of fastening first and second work pieces together of claim 11, wherein the shank is at least partially textured.

13. A method of fastening first and second work pieces together of claim 12, wherein at least part of the shaft is formed during the insertion of the tip and intermediate section.

14. A method of fastening first and second work pieces together of claim 13, wherein the collar further comprises a slit from the exterior of the wall to the interior of the wall.

15. A method of fastening first and second work pieces together of claim 13, further comprising the step of:
crimping the collar against the shank.

16. A method of fastening first and second work pieces together of claim 13, further comprising the step of:
frictionally engaging the shank with the interior of the wall.

17. A method of fastening first and second work pieces together of claim 16, wherein the collar is at least partially frustro-conical and increases in diameter in cross-section from the first collar end.

18. A method of fastening first and second work pieces together of claim 13, further comprising the step of:
inserting the tip into a central borehole of a gasket before inserting the tip into the first workpiece.

19. A method of fastening first and second work pieces together of claim 13, further comprising the step of:
guiding the fastener during insertion with an insertion guide.

20. A fastener assembly kit of parts for fastening work pieces together comprising:
a fastener comprising a tip having cutting means, a shank having a shank end distal to the tip, and a textured intermediate section located between the tip and the shank; and
a collar having first and second ends, and a wall having an exterior and a smooth interior defining a bore.

21. A fastener assembly kit of parts for fastening work pieces together of claim 20, wherein the shank is at least partially textured.

22. A fastener assembly kit of parts for fastening work pieces together of claim 21, wherein the collar further comprises:
a slit from the exterior of the wall to the interior of the wall.

23. A fastener assembly kit of parts for fastening work pieces together of claim 21, wherein the collar is at least partially frustro-conical and increases in diameter in cross-section from the first collar end.

24. A fastener assembly kit of parts for fastening work pieces together of claim 21, further comprising:
at least one gasket with a central borehole.

25. A fastener assembly kit of parts for fastening work pieces together of claim 21, further comprising:
gaskets having opposite gasket ends and a central borehole; and
wherein the gaskets have different shapes.

26. A fastener assembly kit of parts for fastening work pieces together of claim 21, further comprising:
at least one insertion guide.
